(19) United States
(12) Patent Application Publication
(10) Pub. No.: US 2003/0009375 A1
(43) Pub. Date: Jan. 9, 2003

(54) Method for managing a public lottery

(76) Inventors: Klas Stoltz, Staltsjoebaden (SE); Kjell Klang, Stockholm (SE)

Correspondence Address: BROWDY AND NEIMARK, P.L.L.C., 624 NINTH STREET, NW, SUITE 300, WASHINGTON, DC, 20001-5303, US

(21) Appl. No.: 09/899,939

(22) Filed: Jul. 9, 2001

(51) Int. Cl. G06F 17/60

(52) U.S. Cl. 705/14; 705/26

(57) ABSTRACT

The present invention relates to a method for managing a public lottery and more particularly to a method under the control of a computer system which is connected to a telecommunication system, said telecommunication system having subscribers which automatically can be identified in the system by a subscriber identifier, such as a telephone number or other identification code.

### FIELD OF THE INVENTION

The present invention relates to a method for managing a public lottery and more particularly to a method under the control of a computer system which is connected to a telecommunication system, said telecommunication system having subscribers which automatically can be identified in the system by a subscriber identifier, such as a telephone number or other identification code.

### BACKGROUND OF THE INVENTION

There is an increasing demand from the public for the excitement of taking an active part in games and lotteries. There is also a public interest and an increasing demand for raising subscriptions to non-profit associations and charitable societies. As a result of these demands and interests, numerous games and lotteries have been devised and arranged.

### SUMMARY OF THE INVENTION

The object of the present invention is to set forth a method for managing a public lottery, which method provides a flexible and easily accessible lottery system under the control of a computer system.

This object is achieved in accordance with the invention in a method under the control of a computer system which is connected to a telecommunication system, said telecommunication system having subscribers which automatically can be identified in the system by a subscriber identifier, such as a telephone number or other identification code.

In accordance with one aspect of the invention, there is provided a method comprising the steps of connecting electronically subscribers via said telecommunication system with the computer system in response to an action of the subscriber, identifying the connected subscriber by means of the subscriber identifier in the telecommunication system, sending to the connected subscriber a menu of selection information from the computer system, receiving by the computer system selection information in response to a selection action of the subscriber, assigning a unique identification code to the connected subscriber on the basis of the subscriber identifier, sending the unique identification code to the connected subscriber, said code forming a code for a unique lot in the lottery, charging the account of the subscriber of the telecommunication system for the cost of the lot in the lottery, storing said unique identification code in a database in the computer system, and randomising at least one identification code, i.e. one lot, out of a number of identification codes of connected subscribers, which have been assigned by the computer system and stored in the database during a specific period of time, in order to select a subscriber to be identified as a winner in the lottery.

In accordance with another aspect of the invention, there is provided a method comprising the steps of connecting electronically subscribers via said telecommunication system with the computer system in response to an action of the subscriber, identifying the connected subscriber by means of the subscriber identifier in the telecommunication system, assigning a unique identification code to the connected subscriber on the basis of the subscriber identifier, sending the unique identification code to the connected subscriber, said code forming a unique lot in the lottery, charging the account of the subscriber of the telecommunication system for the cost of the lot in the lottery, storing the unique identification code in a database in the computer system, and randomising at least one identification code, i.e. one lot, out of a number of identification codes of connected subscribers, which have been assigned by the computer system and stored in the database during a specific period of time, in order to select a subscriber to be identified as a winner in the lottery.

The method according to the invention provides an easily accessible lottery system to lot buyers, which will increase the number of participators in the lottery. The method according to the invention further provides an opportunity to the managing parties of the lottery, such as for example a television company, a telecommunication company, profit and non-profit associations and charity societies, to profit by the flexibility and the efficiency in the system and by low administrative costs.

### BRIEF DESCRIPTION OF THE DRAWINGS

For a better understanding of this invention, reference should be made to the following detailed description, taken in conjunction with the accompanying drawings, in which

FIG. 1 is an overall system block diagram of a preferred embodiment of the present invention,

FIG. 2 is a block diagram of the computer system of FIG. 1, and

FIG. 3 is a flow chart depicting the operation of a first exemplifying system according to the present invention, and

FIG. 4 is a flow chart depicting the operation of a second exemplifying system according to the present invention.

### DETAILED DESCRIPTION OF THE PREFERRED EMBODIMENTS OF THE INVENTION

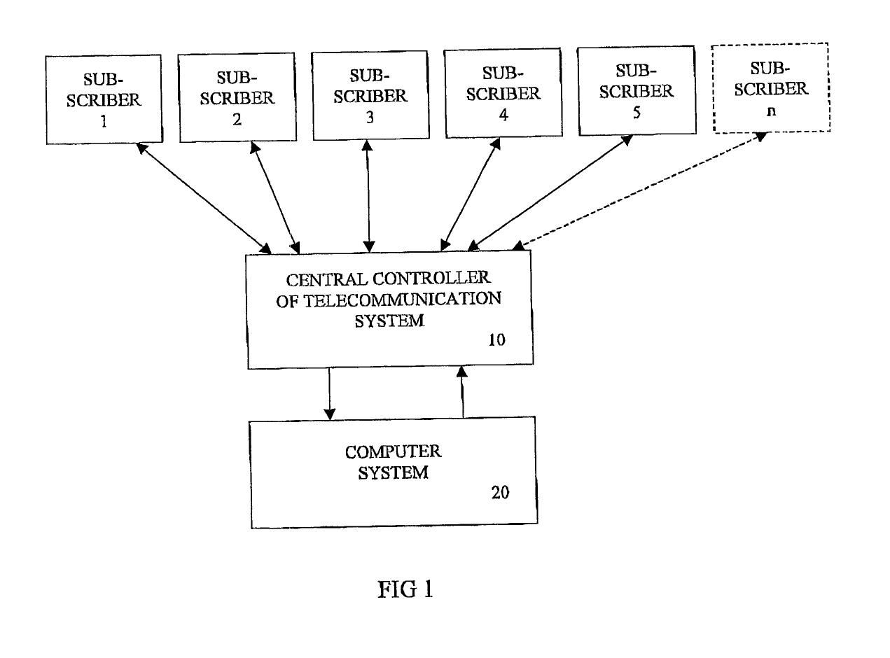

FIG. 1 is an overall system block diagram of a preferred embodiment of the invention. In this embodiment, subscribers (1, 2, 3, . . . n) of a telecommunication system, such as a telephone company, are linked or connected to a central controller 10 of the telecommunication system. A computer system 20, specifically provided to implement the present invention, is linked to the central controller 10 of the telecommunication system. The link between the computer system 20 and the central controller 10 does not have to be a physical link. It can, for example, be a link via a modem or any other link.

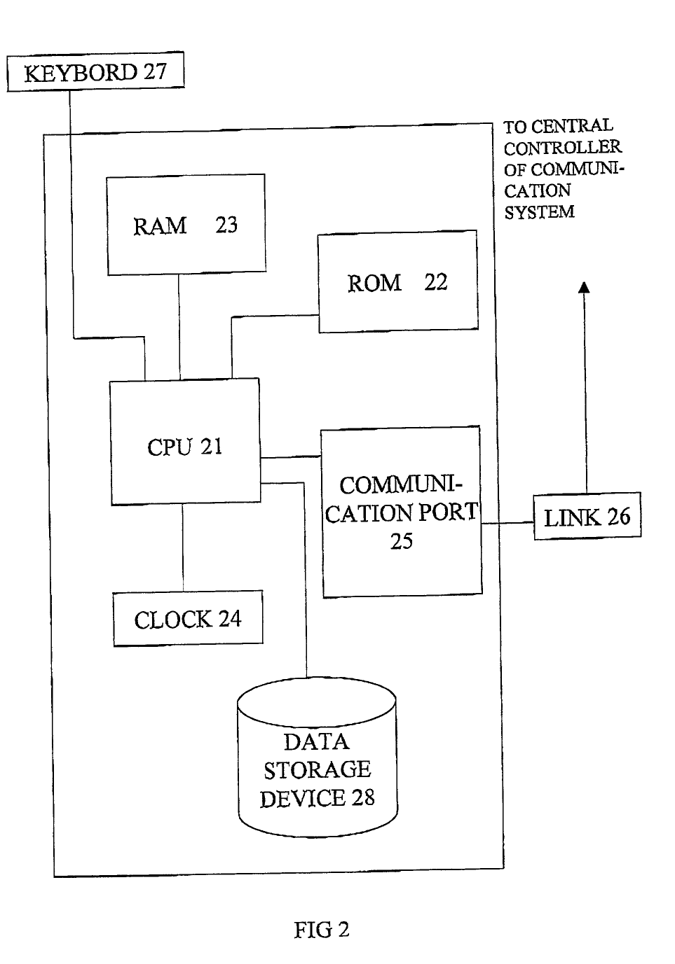

The hardware depicted in FIG. 2 is specifically provided to implement the present invention. FIG. 2 shows a block diagram of a preferred computer system 20, which can be located distal from the central controller 10 of the telecommunication system, preferably in a lottery managing centre, such as a television studio, by way of example.

The computer system 20 preferably includes a CPU 21, ROM 22, RAM 23 and a clock unit 24. The system further includes a communication port 25, preferably interfacing with a modem 26 for establishing communication between the computer system 20 and the central controller 10 of the telecommunication system. Other methods of communicating with external systems may be used instead of modems, such as hard-wired connections, radio communications and optical communications. The computer system also includes an input device 27 to receive input from an operator and interfacing directly with the CPU 21 The system further includes a data storage device 28 in which inter alia processor instructions are stored and these instructions can be read and executed by the CPU 21.

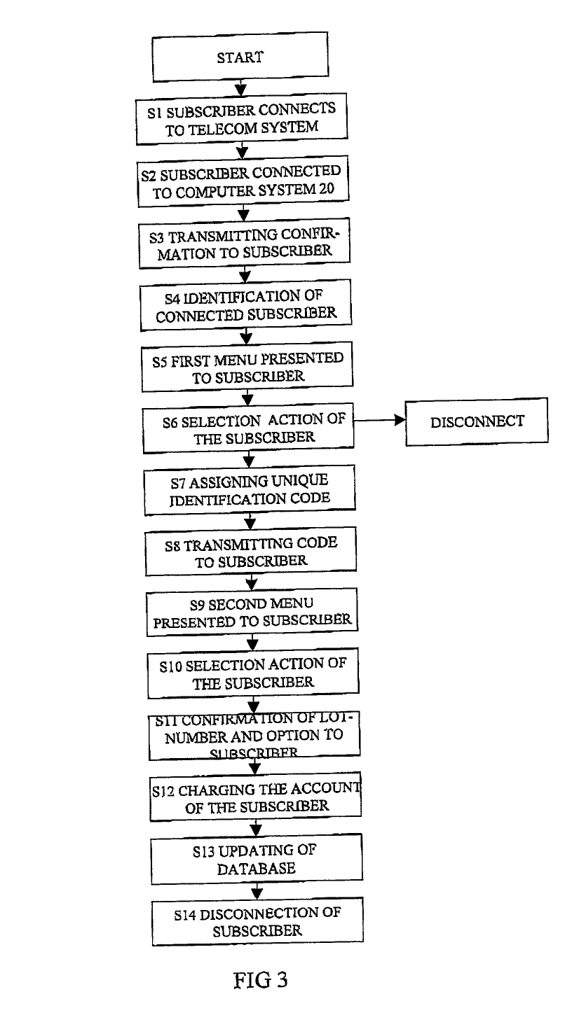

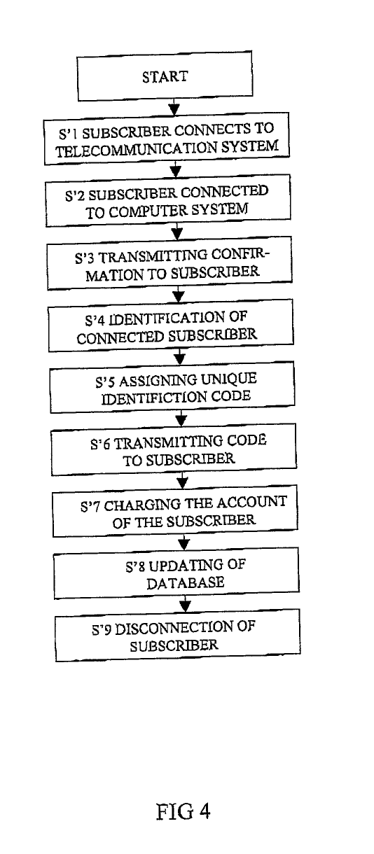

During a predetermined time period, the public, in the form of subscribers of a communication system, such as for example a telecommunication system, may join and take part in the lottery in steps of a process as described below with reference to FIG. 3 or FIG. 4. FIG. 3 and FIG. 4 are flowcharts of processes, which may be implemented in a computer program that may be installed in and operated by the computer system 20, provided to implement the present invention. The computer system 20 is connected to the central controller 10 of the telecommunication system, as shown in FIG. 1.

The process starts when information about a specific lottery and its terms and conditions have been made available to the public. The public may be informed of the lottery in a radio or television program, on the Internet, in a publicity campaign or the like. The lottery may be arranged in co-operation with a telecommunication company, such that all the subscribers of the telecommunication system may take part in the lottery. The subscribers of the telecommunication system can be automatically identified in the system by a subscriber identifier, when a connection to the system is established in response to an action of the subscriber.

As shown in FIG. 3, a person who decides to take part in the lottery, starts by establishing, in a first step S1, a connection with a central controller 10 of the telecommunication system. The connection can be established by an ordinary phone call to a specific telephone number or by pressing a button on a keyboard connected to a webside on the Internet or in any other convenient way. The specific telephone number is open for connection during a specific time period, i.e. from a starting point in time of the lottery to the closing down point in time. The central controller 10 of the telecommunication system identifies the specific telephone number and as a consequence connects, in a second step S2, the subscriber to the lottery managing computer system 20.

A text on a display or an automatic voice, confirming the connection of the subscriber to the lottery managing computer system, is transmitted to the subscriber in a step S3. In a further step, step S4, the connected subscriber is automatically identified by means of the subscriber identifier, such as the subscriber telephone number or other subscriber identification code, and the subscriber identifier is stored in the computer system. In step S5 a first menu M1 of selection information is transmitted to the subscriber by the system. The menu M1 may comprise selection information, such as “disconnect—press 9”, “purchase 1 lot—press 1”. The menu M1 may include further selection information, such as “purchase 2 lots—press 2”, “purchase 3 lots—press 3”, . . . etc. However, an option to purchase one lot only is preferred. In step S6, the subscriber decides whether to purchase one lot or to disconnect by making a selection action, i.e. by pressing the denoted button or speaking the denoted sound, said information being transmitted to the computer system. If the subscriber selects the disconnecting option, the connection to the lottery managing computer system and the telecommunication system is disconnected and the account of the subscriber is charged for an ordinary telecommunication fee.

If the subscriber selects to purchase a lot, the computer system in step S7 calculates and assigns a unique identification code to the lot. The unique identification code is based on the subscriber identifier, such as the telephone number of the subscriber or another identification code and may be combined with a random number or other information from the computer system database (data storage device 28). In step S8 the unique identification code is transmitted to the connected subscriber as a confirmation of a purchased lot and as a lot number, said code being presented on a display or as a speaking sound.

If the subscriber in step S6 decides to purchase more than one lot, the computer system in step S7 may either assign one and the same unique code to all purchased lots of a connected subscriber or assign one unique code to each of the purchased lots of a connected subscriber.

In step S9, a second menu M2 of selection information may be transmitted to the subscriber by the system. This menu M2 may comprise selection information in the form of a list of different objects, e.g. charity objects or non-profit associations such as the Red Cross, Amnesty International and the like, one of which is to be selected by the connected subscriber to be the recipient of all or part of the charged amount for the lot. In step S10, the subscriber decides which object to select as a recipient by making a selection action, e.g. by pressing a button or speaking a sound, said input information being transmitted to the computer system. In step S11, the computer system confirms to the connected subscriber the lot number and the selected option of recipient. Further menus may be presented to the subscriber by the system.

In a step S12, the account of the connected subscriber is charged for the cost of the lot. Of course, alternate methods of payment may be used, including charging the subscriber's credit card. In step S13, the lottery database is updated to reflect the fact that a lot having a specified identification code has been sold to an identified subscriber. In the case described above when several lots purchased by one subscriber have been assigned one and the same identification code, the database is updated to reflect the fact that several lots having a specified identification code have been sold to an identified subscriber. In a finalising step S14 the subscriber is disconnected from the computer and telecommunication systems.

In the alternative system as shown in FIG. 4, a person who decides to take part in the lottery, starts by establishing, in a first step S′1, a connection with the central controller 10 of the telecommunication system. In step S′2 the subscriber is connected to the lottery managing computer system 20 analogous to the corresponding steps S1 and S2 of FIG. 3. In step S′3 a confirmation of the connection to the lottery managing computer system is transmitted to the subscriber and in step S′4 the connected subscriber is identified by means of the subscriber identifier analogous to the corresponding steps S3 and S4 of FIG. 3. However, in step S′5 the computer system calculates and assigns a unique identification code to a lot which has been purchased by the action of the connected subscriber, i.e. by the connection of the subscriber to the telecommunication system. In step S′6 the unique identification code is transmitted to the connected subscriber as a confirmation of a purchased lot and as a lot number, said code being presented on a display or as a speaking sound. In step S′7 the account of the connected subscriber is charged for the cost of the lot and in step S′8 the lottery database is updated to reflect the fact that a lot having a specified identification code has been sold to an identified subscriber. In a finalising step S′9 the subscriber is disconnected from the computer and telecommunication systems.

During the time period when the lottery is open to subscribers of the telecommunication system to purchase lots in the lottery, the lottery database data storage device is continuously updated to include information of subscribers being connected according to the processes as disclosed with reference to FIG. 3 and to FIG. 4. The information in the lottery database (data storage device 28 of the computer system) is subsequently used in operation of the computer system when a winner or winners in the lottery is/are to be selected. The steps of this process may be stored on a computer readable medium and the winner in the lottery is selected from the database as a random number.

It will be understood that the invention is not restricted to the aforedescribed exemplifying embodiments thereof and that several conceivable modifications of the invention are possible within the scope of the following claims.

1. A method for managing a public lottery under the control of a computer system, which is connected to a telecommunication system, said telecommunication system having subscribers which automatically can be identified in the system by a subscriber identifier, such as a telephone number or other identification code, said method comprising the steps of:
connecting electronically subscribers via said telecommunication system with the computer system in response to an action of the subscriber,
identifying the connected subscriber by means of the subscriber identifier in the telecommunication system,
sending to the connected subscriber a menu of selection information from the computer system,
receiving by the computer system selection information in response to a selection action of the subscriber,
assigning a unique identification code to the connected subscriber on the basis of the subscriber identifier,
sending the unique identification code to the connected subscriber, said code forming a code for a unique lot in the lottery, charging the account of the subscriber of the telecommunication system for the cost of the lot in the lottery,
storing said unique identification code in a database in the computer system, and
randomising at least one identification code, i.e. one lot, out of a number of identification codes of connected subscribers, which have been assigned by the computer system and stored in the database during a specific period of time, in order to select a subscriber to be identified as a winner in the lottery.

2. A method of claim 1, wherein the computer system is sending a menu of selection information comprising different quantities of lots, e.g. 1, 2, 3, . . . etc, to be selected by the connected subscriber.

3. A method of claim 2, wherein the computer system is sending a menu of selection information comprising different objects, e.g. charity objects, to be selected by the connected subscriber to be the recipient of all or part of the charged amount for the lot.

4. A method of claim 3, wherein the menu of selection information is presented to the connected subscriber in the form of a speaking voice.

5. A method of claim 3, wherein the menu of selection information is presented to the connected subscriber as displayed information on a screen.

6. A method of claim 1, wherein the unique identification code is based on a combination of the subscriber identifier and a personal code or other type of code, said personal code or other type of code having been transmitted to the computer system in response to an action of the connected subscriber.

7. A method of claim 1, wherein said unique identification code of a connected subscriber is forming a code for at least two lots in the lottery.

8. A method of claim 7, wherein said unique identification code of the connected subscriber is transmitted to the computer system, and the lottery database in said system is updated such that said unique code is stored, once for each purchased lot of the connected subscriber.

9. A method of claim 1, wherein the public lottery is part of a television program.

10. A method of claim 1, wherein the action of the subscriber consists of clicking buttons.

11. A method of claim 1, wherein the action of the subscriber consists of speaking sounds.

12. A method for managing a public lottery under the control of a computer system, which is connected to a telecommunication system, said telecommunication system having subscribers which automatically can be identified in the system by a subscriber identifier, such as a telephone number or other identification code, said method comprising the steps of:
connecting electronically subscribers via said telecommunication system with the computer system in response to an action of the subscriber,
identifying the connected subscriber by means of the subscriber identifier in the telecommunication system,
assigning a unique identification code to the connected subscriber on the basis of the subscriber identifier,
sending the unique identification code to the connected subscriber, said code forming a unique lot in the lottery,
charging the account of the subscriber of the telecommunication system for the cost of the lot in the lottery,
storing the unique identification code in a database in the computer system, and
randomising at least one identification code, i.e. one lot, out of a number of identification codes of connected subscribers, which have been assigned by the computer system and stored in the database during a specific period of time, in order to select a subscriber to be identified as a winner in the lottery.
